(19) United States
(12) Patent Application Publication
(10) Pub. No.: US 2012/0308694 A1
(43) Pub. Date: Dec. 6, 2012

(54) APPARATUS AND METHODOLOGY FOR EVEN DEFROSTING OF FROZEN FOOD PRODUCTS

(76) Inventors: William D. Price, Midland, MI (US); Jeramy M. Dubay, Hope, MI (US)

(21) Appl. No.: 13/152,391

(22) Filed: Jun. 3, 2011

(51) Int. Cl. A23L 3/365; A23L 3/36

(52) U.S. Cl. 426/241; 62/1; 99/483

(57) ABSTRACT

An article of manufacture for freezing and thawing foodstuffs wherein the defrosting unit has: (a) a first half having a void space for loading foodstuff; and (b) a second half having a void space for loading foodstuff. The first half and second half may be aligned such that the void spaces are continuous. Further, the first half and second half are securely joinable to substantially cover the void spaces.

### CROSS REFERENCE TO RELATED APPLICATIONS

Not Applicable.

### REFERENCE REGARDING FEDERALLY SPONSORED RESEARCH OR DEVELOPMENT

Not Applicable.

### SEQUENTIAL LISTING

Not Applicable.

### FIELD OF THE INVENTION

Our invention relates to a method and apparatus for providing controlled thawing of food products. In particular, our invention relates to a method and apparatus for providing the rapid thawing of ground meat such that the meat is relatively evenly thawed and wherein the thawed meat does not undergo any unwanted cooking during the thawing or defrosting process.

### BACKGROUND OF THE INVENTION

Buying food items ahead of time is a convenient option for consumers. Food which is purchased during a routine trip to the grocery store may be used when the consumer needs it. However, due to the perishable nature of food products, there is often a need to store advanced purchased food items for some time before the food is actually used. Highly sensitive foodstuffs, such as meats, must be frozen. However, it is common to purchase such items in advanced as it is beneficial to have such foodstuffs available for preparing meals on short notice when there isn't enough time to purchase fresh ingredients, including meat.

Certain types of foods which are bought in advance, such as ground meat, may be stored in the freezer and then thawed out at a later time. However, many consumers have issues with using the frozen ground meat due to issues with defrosting such meat. In certain instances, a consumer is unable to plan ahead and defrost frozen ground meat in the refrigerator and will resort to using the defrost setting on the user's microwave to thaw out the meat. Often times, the microwave setting will cause the meat on the outer surface of the frozen mass to actually cook—effectively ruining the flavor and texture of the meat while failing to properly thaw out the inner portion of the meat—causing issues when the meat is to be prepared. Additional drawbacks to defrosting a large mass of frozen food is that such a mass may take a relatively long length of time compared to mass of food that is strategically oriented.

Thus, there is a need for an apparatus or method for thawing out frozen ground meat in the microwave in such a way that the frozen ground meat is thawed evenly and without cooking certain portions of the meat.

### SUMMARY OF THE INVENTION

In a first nonlimiting embodiment, the present invention is directed to an article of manufacture for freezing and thawing foodstuffs wherein the defrosting unit comprises: (a) a first half having a void space for loading foodstuff; (b) a second half having a void space for loading foodstuff; wherein the first half and second half may be aligned such that the void spaces are continuous, and wherein the first half and second half are securely joinable to substantially cover the void spaces.

In a second nonlimiting embodiment, the present invention is directed to an article of manufacture for freezing and thawing foodstuffs wherein the defrosting unit comprises: (a) a first half; wherein the first half comprises a first boundary unit and a second boundary unit, wherein one or more extensions holds the first boundary unit and second boundary unit in a fixed position relative position and provides a void space between the first boundary unit and the second boundary unit; (b) a second half; wherein the second half comprises a first boundary unit and a second boundary unit, wherein one or more extensions holds the first boundary unit and second boundary unit in a fixed position relative position and provides a void space between the first boundary unit and the second boundary unit; and wherein the first half and second half are securely joinable to substantially cover the void spaces.

In a third nonlimiting embodiment, the present invention is directed to a method of storing and defrosting a frozen foodstuff comprising the steps of: (a) providing the user with a defrosting unit, the defrosting unit comprising a first half having a void space and a second half having a void space, the first half and the second half being detachably connectable; (b) directing the user to load compressible foodstuff into the void space of the first half to provide a loaded defrosting unit; (c) directing the user to connect the first half to the second half to provide a sealed defrosting unit; (d) directing the user to freeze the sealed defrosting unit; and (e) directing the user to use put the loaded defrosting unit into the microwave oven to thaw the foodstuff.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings in which:

FIG. 1 provides a side view of a nonlimiting embodiment of a defrosting unit.

FIG. 2 provides a perspective view of the cross-section of the defrosting unit of FIG. 1 taken along line 2-2.

FIG. 3 provides a side view of a nonlimiting embodiment of a defrosting unit.

FIG. 4(a) provides a perspective view of a nonlimiting embodiment of a first half of a defrosting unit.

FIG. 4(b) provides a perspective view of a nonlimiting embodiment of a second half of a defrosting unit.

FIG. 5 provides a front view of a nonlimiting embodiment of a defrosting unit as it may be used in a microwave oven.

FIG. 6 provides a flow chart of a nonlimiting embodiment of a process for directing users to use a defrosting unit.

### DETAILED DESCRIPTION OF THE INVENTION

One of skill in the art will appreciate that many, if not all, commercially available a microwave ovens work by passing non-ionizing microwave radiation through food or whichever material or substance is in the microwave. Water, fat, and other substances in the food absorb energy from the microwaves in a process called dielectric heating. Materials without an electric dipole will not absorb the microwave energy. Additionally, contrary to common misperception, microwave ovens do not literally heat a material from the inside out (i.e., from the center of the entire mass of food outwards) and microwave heating, like conventional heating in an oven, works by applying energy to the outer layers of the mass of food first.

### Defrosting Unit

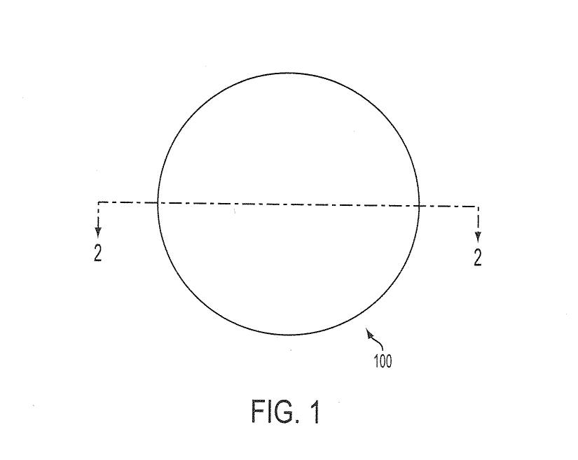

FIG. 1 provides a side view of a defrosting unit 100 according to a nonlimiting embodiment of the present invention. In the embodiment shown, the defrosting unit may be substantially cylindrical.

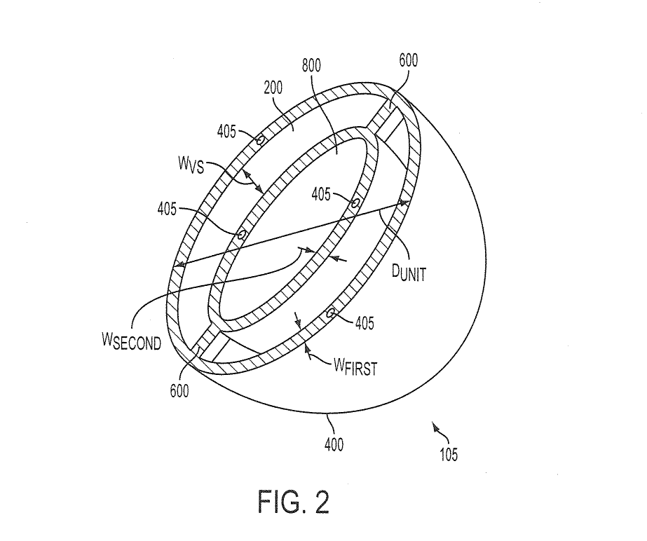

FIG. 2 provides a perspective view of a first half 105 of a defrosting unit 100 taken along line 2-2 the nonlimiting embodiment shown in FIG. 1. The defrosting unit 100 comprises a first boundary unit 400 that substantially surrounds a second boundary unit 800 such that there is a cavity or void space 200 provided between the first boundary unit 400 and second boundary unit 800. The first boundary unit 400 and second boundary unit 800 may be held a relatively concentric arrangement using extensions 600 between the spheres (400, 800) or by any other mechanical mechanism that is suitable. In some embodiments the first and second boundary units are spheres. One will appreciate that because a defrosting unit 100 may be provided as two attachable parts, the boundary units and/or the void space there between may be actually semi-spherical for each half. In other embodiments first and second boundary units may be cylinders having face shapes selected from the group consisting of: ovals, triangles, squares, rectangles, the like, and combinations thereof. In another embodiment, the first and second boundary units may have sides selected from the group consisting of: parabolas, parabolic arches, straight lines, curved lines, step functions, the like, and combinations thereof.

The second boundary unit 800 may be hollow in order to reduce the cost of making the invention due to the need for less material. Also, having less material will reduce any, even minimal, absorption of microwave energy, thus allowing the energy to be focused onto the foodstuff being defrosted.

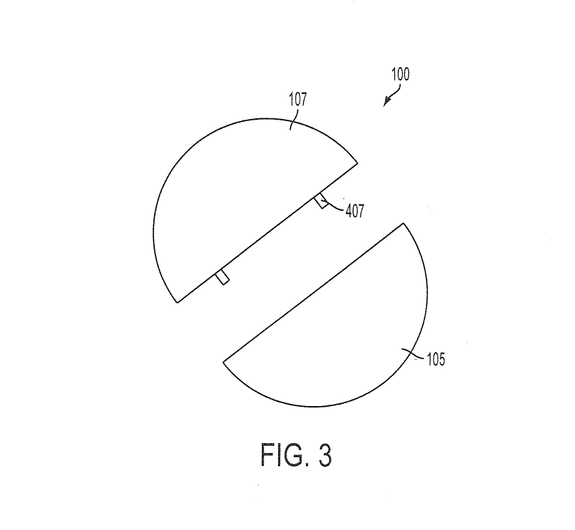

The first half 105 of the defrosting unit 100 may be guided together with the second half 107 of the defrosting unit 100 (FIG. 3) by providing one or more aligning protrusions 407 extending from the second half 107 wherein the aligning protrusions fit into receiving wells (405, FIG. 2).

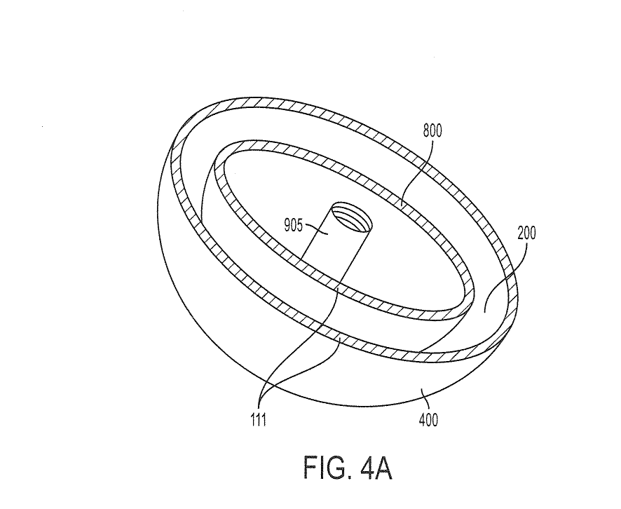

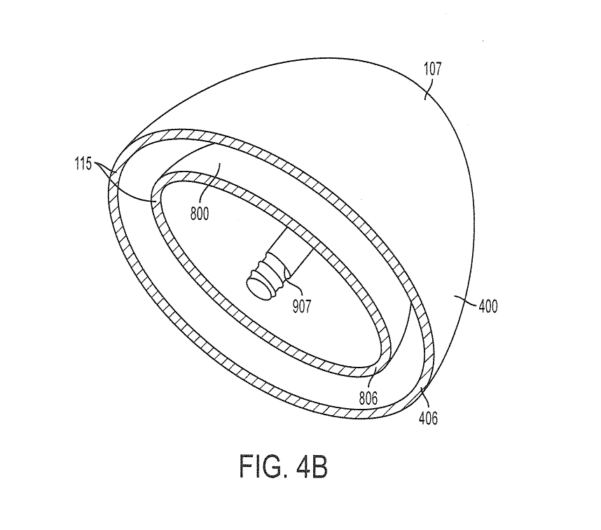

FIG. 4(a) shows an exemplary embodiment of the first half 105 of a defrosting unit 100 wherein a female threaded guide 905 wherein the female threaded guide may align and fit with a male threaded guide 907 of the second half 107 (FIG. 4(b)) of the defrosting unit 100. In one embodiment the male and female guides (907, 905) may be positioned in the center of the second boundary unit 800 such that when the two guides are screwed together the first half 105 and second half 107 form the sphere such that there is no gapping between the first and second halves to prevent leaking of fluids from any meat product that is defrosted using the defrosting unit 100. One benefit of using a female threaded guide 905 and a male threaded guide 907 is that upon screwing the first half 105 and the second half 107 of the defrosting unit 100 together, the screw will hold the first and second halves in place at the sealing surfaces of the first and second halves (111, 115, respectively). Optionally, a first gasket 406 and/or a second gasket 806 may be provided on the sealing surface of the second half (or on the sealing surface first half, not shown). It is thought that a sealing surface of the first and second halves may be substantially planar to provide for a liquid-tight seal between the first and second halves when the unit is sealed together. In certain embodiments the male and/or female threaded guides extend in a direction that is substantially perpendicular to the plane of the sealing surface.

The void space (200, FIG. 2) has a volume that is directly tied to the difference in volumes of the first boundary unit and the second boundary unit. While the thinner the width of the void space (W_{VS}) between the first boundary unit and the second boundary unit, the void space must be easy enough to access and load/unload. In one embodiment the width of the void space (W_{VS}) may be held substantially constant between the two spheres. In a particular embodiment the width of the void space is from about ¼″ to about ¾″. In another embodiment the width of the void space (W_{VS}) is from about ⅜″ to about ⅝″. In yet another embodiment the width of the void space (W_{VS}) is from about ½″ to about ⅝″.

In an embodiment wherein the first boundary unit 400 and the second boundary unit 800 are hollow spheres having walls, the width of the wall of the first wall (W_{first}) is from about 0.10 inches to about 0.2 inches. In a different embodiment, the width of the wall of the first wall (W_{first}) is from about 0.10 inches to about 0.15 inches. In an embodiment the width of the second wall (W_{second}) is from about 0.10 inches to about 0.2 inches. In an embodiment the width of the second wall (W_{second}) is from about 0.10 inches to about 0.15 inches. In an embodiment the diameter of the unit (Dᵤₙᵢₜ, measured from the inner surface of the first wall) is from about 3 inches to about 6 inches. In another embodiment the diameter of the unit (Dᵤₙᵢₜ) is from about 4 inches to about 5 inches. In an embodiment the dimensions of a defrosting unit 100 are such that there is a total void space volume of from about 25 cubic inches to about 40 cubic inches. In another embodiment the total void space volume is from about 28 cubic inches to about 32 cubic inches. It should be known that each half has a void space 200 wherein the total volume for storage and/or thawing of foodstuff of the defrosting unit 100 is twice that of the volume of each half That is, the total volume (useable) of a defrosting unit is from about the volume of a closed unit (sphere in the embodiments shown in the figures).

Alternative geometries of the first boundary unit and second boundary units (i.e., not spheres) may provide for variable void space widths throughout the defrosting unit 100.

In some embodiments the defrosting unit 100 may be made of a compressed paper material, PET, polypropylene, polystyrene, HDPE, ceramics, glass, rigid silicone, the like, and combinations there of.

### Attachment of First and Second Boundary Units

FIG. 7(a) provides a nonlimiting embodiment of a first half 105 of a defrosting unit 100 wherein the first boundary unit 400 and the second boundary unit 800 are separated. Specifically in the embodiment shown in FIG. 7(a) there is a stem 830 extending outwardly from, and perpendicular to, the convex surface of the secondary boundary unit 800. As shown in the figure, the key 838 forms a perpendicular surface to the stem 830 and has a width W_{key}.

FIG. 7(b) is a view of the concave surface of the first boundary unit 400 of FIG. 7(a). In the embodiment of FIG. 7(b) the first boundary unit 400 has a receiving extension 447, which may serve as an extension (600, FIG. 2) to hold the first and second boundary units 400, 800 apart and provide a void space 200. Accordingly, the height of the receiving extension 447 and spacers 449, which may also be used to separate the first and second boundary units 400, 800, is also going the same as the width of the void space.

The receiving extension 447 may have a keyhole 442 for receiving the key 838 from the secondary boundary unit. The width of the keyhole 442 is sized such that the keyhole 442 may receive the key 838. Upon fully combining the key 838 through the keyhole 442, the key 838 will align with one or more locking tabs 443 at the concave surface of the first boundary unit 400. In the embodiment shown the locking tabs 443 are simply formed by not cutting out certain areas of a circle from the surface of the first boundary unit 400. In particular, the circle is cut around the receiving extension 447 having the keyhole. The locking tabs around the keyhole provide a means by which the key can be turned in the open venting area 440 (circle) such that the first and second boundary units are held in a fixed relative configuration.

First and second halves 105 and 107, respectively may be held in fixed relative position by a small tab or extension 414 from one half and a recess 413 or other friction fit element on the other half to provide a mechanical engagement between the two halves. This is exemplified in FIG. 8.

### Loading/Method of Use

Ground meat or other compressible foodstuff may be loaded into the void space 200 between the first boundary unit 400 and the second boundary unit 800 (FIG. 2). By providing a hollow center area and/or a center area which will not need to receive microwave energy (i.e., because nothing there needs to be defrosted). The defrosting unit 100 as exemplified herein provides the foodstuff into a hollow spherical form. As discussed, particular embodiments of a defrosting unit 100 may not necessarily be required to provide a hollow spherical form to frozen foodstuff, but that the defrosting unit 100 may provide a hollow center area to the frozen foodstuff. The hollow spherical foodstuff may then be frozen. When the user is ready to defrost the frozen foodstuff, the user may place the defrosting unit having frozen foodstuff into the user's microwave oven.

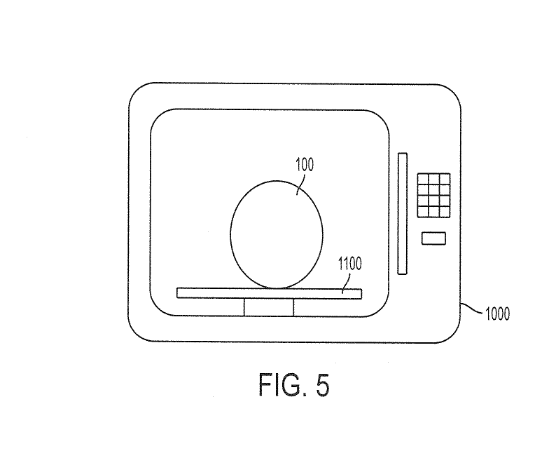

In one embodiment shown in FIG. 5, a defrosting unit 100 is provided into a microwave oven 1000. The microwave oven is equipped with an optional carousel tray 1100 to provide rolling motion to the defrosting unit 100. It is thought having a spherical defrosting unit 100, there will be a relatively high degree of randomness in the movement of the defrosting unit 100. This may be particularly beneficial because many microwave ovens may have non-uniform distribution of microwave energy within the oven itself, thus allowing for a more even thawing of the frozen foodstuff.

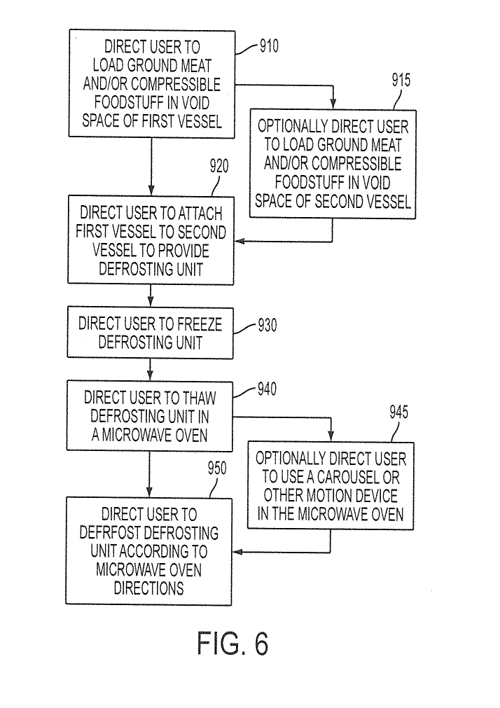

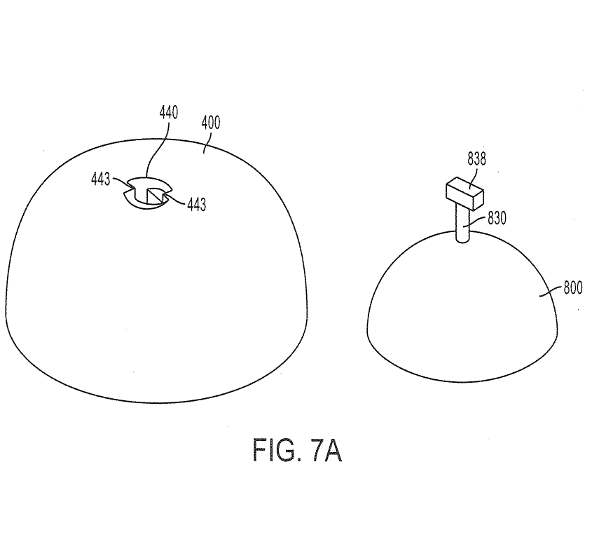

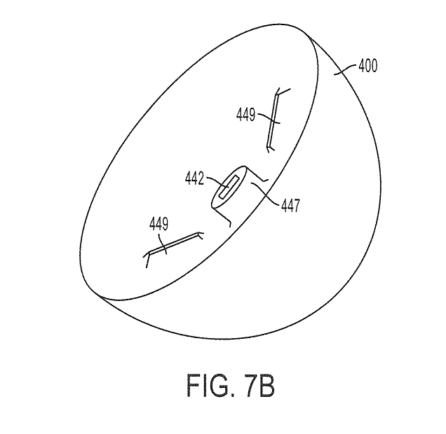

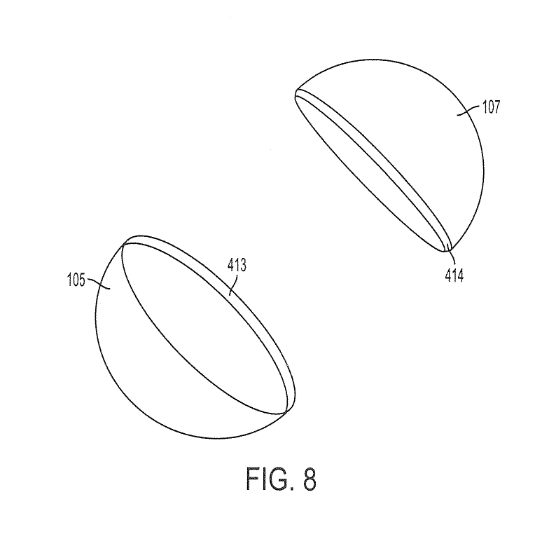

While it is thought that the a defrosting unit which resembles a sphere or ball will inherently roll randomly in a microwave unit even without the assistance of motion from a carousel tray, in embodiments wherein the microwave oven being used does not have a carousel tray, the user may be directed to optionally utilize some sort of external device to provide a rolling motion to the defrosting unit. An exemplary set of instructions 900 which may be provided to the user is provided in the chart of FIG. 6.

The user may be directed to load ground meat and/or any appropriate compressible (or otherwise formable, pliable, or moldable) foodstuff into the void space of the first half 910. The user may then optionally be directed to load ground meat and/or any appropriate compressible foodstuff into the void space of the second half 915. The user may then be directed to attach the first half to the second half using any attachment means provided with the boundary unit, and as may be described herein, to provide a loaded defrosting unit 920. The user may be directed to freeze the loaded defrosting unit 930. The user may then be directed to thaw the loaded defrosting unit in a microwave 940. The user may be optionally directed to use a carousel, or other suitable means for providing motion to the loaded defrosting unit in the microwave oven. The user may also be directed to defrost the loaded defrosting unit in the microwave oven according to any directions and/or settings provided in or with the microwave oven 950.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention.

We claim:

1. An article of manufacture for freezing and thawing foodstuffs wherein the defrosting unit comprises:
a) a first half having a void space for loading foodstuff;
b) a second half having a void space for loading foodstuff; wherein the first half and second half may be aligned such that the void spaces are continuous, and wherein the first half and second half are securely joinable to substantially cover the void spaces.

2. The article of manufacture according claim 1 wherein the total void space volume is from about 25 cubic inches to about 40 cubic inches

3. The article of manufacture according claim 2 wherein the total void space volume is from about 28 cubic inches to about 32 cubic inches

4. The article of manufacture according to claim 1 wherein the void space of the first half is substantially semi-spherical.

5. The article of manufacture according to claim 1 wherein the void space of the second half is semi-spherical.

6. The article of manufacture according to claim 1 wherein the article of manufacture is substantially spherical.

7. An article of manufacture for freezing and thawing foodstuffs wherein the defrosting unit comprises:
a) a first half;
wherein the first half comprises a first boundary unit and a second boundary unit, wherein one or more extensions holds the first boundary unit and second boundary unit in a fixed position relative position and provides a void space between the first boundary unit and the second boundary unit;
b) a second half;
wherein the second half comprises a first boundary unit and a second boundary unit, wherein one or more extensions holds the first boundary unit and second boundary unit in a fixed position relative position and provides a void space between the first boundary unit and the second boundary unit; and
wherein the first half and second half are securely joinable to substantially cover the void spaces.

8. The article of manufacture according to claim 7 wherein the first half comprises one or more aligning protrusions extending therefrom.

9. The article of manufacture according to claim 8 wherein the second half comprises one or more receiving wells, wherein the aligning protrusions are matably receivable by the receiving wells.

10. The article of manufacture according to claim 7 wherein the first half further comprises a female threaded guide which is aligned substantially perpendicular relative to the plane of the sealing surface of the first half.

11. The article of manufacture according to claim 10 wherein the second half further comprises a male threaded guide which is aligned substantially perpendicular relative to the plane of the sealing surface of the second half.

12. The article of manufacture according to claim 11 wherein the male threaded guide extends from the plane of the sealing surface.

13. The article of manufacture according to claim 7 wherein a gasket may be juxtaposed between the first half and the second half when the first half and second half are securely joined.

14. The article of manufacture according to claim 7 wherein the first boundary and second boundary units of the first half and the first boundary and second boundary units of the second half are substantially semi-spherical and wherein the first and second boundary units of the first half are concentric relative to each other and the first and second boundary units of the second half are concentric relative to each other.

15. A method of storing and defrosting a frozen foodstuff comprising the steps of:
a) providing the user with a defrosting unit, the defrosting unit comprising a first half having a void space and a second half having a void space, the first half and the second half being detachably connectable;
b) directing the user to load compressible foodstuff into the void space of the first half to provide a loaded defrosting unit;
c) directing the user to connect the first half to the second half to provide a sealed defrosting unit;
d) directing the user to freeze the sealed defrosting unit; and
e) directing the user to use put the loaded defrosting unit into the microwave oven to thaw the foodstuff.

16. The method according to claim 15 wherein the method further comprises step:
a)(1) directing the user to load compressible foodstuff into the void space of the second half; wherein step a)(1) takes place after step a) and before step c).

17. The method according to claim 15 wherein the method further comprises step:
f) directing the user to provide rolling motion to the sealed defrosting unit while the sealed defrosting unit is being heated in the microwave; wherein step f) takes place after step e).

18. The method according to claim 15 wherein the method further comprises step:
g) directing the user to defrost the frozen foodstuff according to directions provided by the manufacturer of the microwave; wherein step g) takes place after step e).
